(19) United States
(12) Patent Application Publication
(10) Pub. No.: US 2018/0349337 A1
(43) Pub. Date: Dec. 6, 2018

(54) INK MODE CONTROL

(71) Applicant: Microsoft Technology Licensing, LLC, Redmond, WA (US)

(72) Inventors: Shirui CHENG, Lund (SE); Lukasz Stanislaw SPAS, Lund (SE); Karl WITTENMARK, Lund (SE)

(21) Appl. No.: 15/615,823

(22) Filed: Jun. 6, 2017

(51) Int. Cl. G06F 17/24; G06K 9/00; G06K 9/22; G06F 3/0481; G06F 3/0488; G06F 3/0354

(52) U.S. Cl. CPC G06F 17/242; G06K 9/00416; G06F 3/03545; G06F 3/0481; G06F 3/04883; G06K 9/222

(57) ABSTRACT

A computing device is described which has a media content viewer configured to render content comprising an image or a video at a display associated with the computing device. The computing device has a processor configured to operate in at least an ink control mode and an ink authoring mode. In the ink control mode at least one ink control element is rendered over a display of the content, the ink control element being selectable by a user to change settings for electronic inking over the content. In the ink authoring mode user input generates electronic ink over the content. An ink mode controller is configured to monitor for and detect specified conditions, and when the specified conditions are detected, to trigger transitioning of the processor between the ink control mode and the ink authoring mode.

### BACKGROUND

Electronic ink is typically drawn or written on a touch screen computing device such as an electronic white board, a tablet computer, a smart phone or other touch screen device. Facilitating input of electronic ink to such touch screen computing devices is an ongoing issue.

The embodiments described below are not limited to implementations which solve any or all of the disadvantages of known electronic ink systems.

### SUMMARY

The following presents a simplified summary of the disclosure in order to provide a basic understanding to the reader. This summary is not intended to identify key features or essential features of the claimed subject matter nor is it intended to be used to limit the scope of the claimed subject matter. Its sole purpose is to present a selection of concepts disclosed herein in a simplified form as a prelude to the more detailed description that is presented later.

A computing device is described which has a media content viewer configured to render content comprising an image or a video at a display associated with the computing device. The computing device has a processor configured to operate in at least an ink control mode and an ink authoring mode. In the ink control mode at least one ink control element is rendered over a display of the content, the ink control element being selectable by a user to change settings for electronic inking over the content. In the ink authoring mode user input generates electronic ink over the content. An ink mode controller is configured to monitor for and detect specified conditions, and when the specified conditions are detected, to trigger transitioning of the processor between the ink control mode and the ink authoring mode.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a schematic diagram of a computing device which has functionality to control ink modes in order to facilitate input of electronic ink to the computing device;

FIG. 2 is a schematic diagram of an image displayed on a laptop computer and showing viewing controls;

FIG. 3 is a schematic diagram of the image of FIG. 2 where the viewing controls are hidden and ink controls are visible;

FIG. 4 is a schematic diagram of the image of FIG. 3 where electronic ink has been drawn on to the image;

FIG. 5 is a schematic diagram of a video frame depicting a woman and showing viewing controls including a video timeline;

FIG. 6 is a schematic diagram of the video frame of FIG. 5 and showing electronic ink which has been drawn onto the video frame;

FIG. 7 is a schematic diagram of a woman using her finger to draw electronic ink onto a video;

FIG. 8 is a schematic diagram of a woman using her finger to draw electronic ink onto a video;

FIG. 9 is a state transition diagram for a computing device having an ink mode controller;

FIG. 10 is a flow diagram of a method at an ink mode controller; and

FIG. 11 illustrates an exemplary computing-based device in which embodiments of an ink mode controller are implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present example are constructed or utilized. The description sets forth the functions of the example and the sequence of operations for constructing and operating the example. However, the same or equivalent functions and sequences may be accomplished by different examples.

Electronic ink is a form of digital writing or drawing, which is akin to conventional ink writing or drawing, and which is made by manual user input at a user interface of a computing device. The term “ink stroke” is used herein to refer to an electronic ink stroke. A non-exhaustive list of examples of types of manual user input for electronic inking is: mouse input, touch screen input, pointing user input, stylus input. In the case of mouse input a user operates a relative position indicator such as a conventional computer mouse to control a position indicator such as a cursor on a graphical user interface of a computer. As the user clicks and drags the mouse an electronic ink stroke is input to the computer. The electronic ink stroke ends when the user stops the click action. As the user repeats the clicking and dragging operation, further electronic ink strokes are created.

In the case of touch screen input, a user touches a touch screen with his or her finger and drags his or her finger along the touch screen to create an electronic ink stroke. When the finger loses contact with the touch screen the electronic ink stroke ends. Where the touch screen is hover sensitive, the finger creates electronic ink when it is within a hover sensitive range of the touch screen. The term “touch screen” is used herein to include hover sensitive screens.

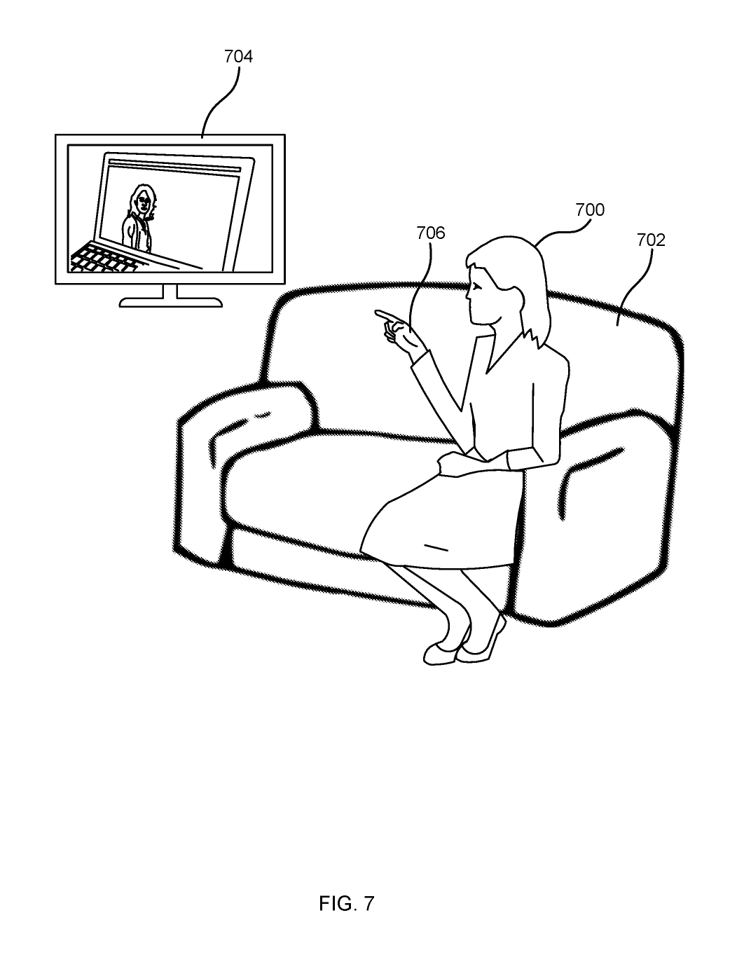

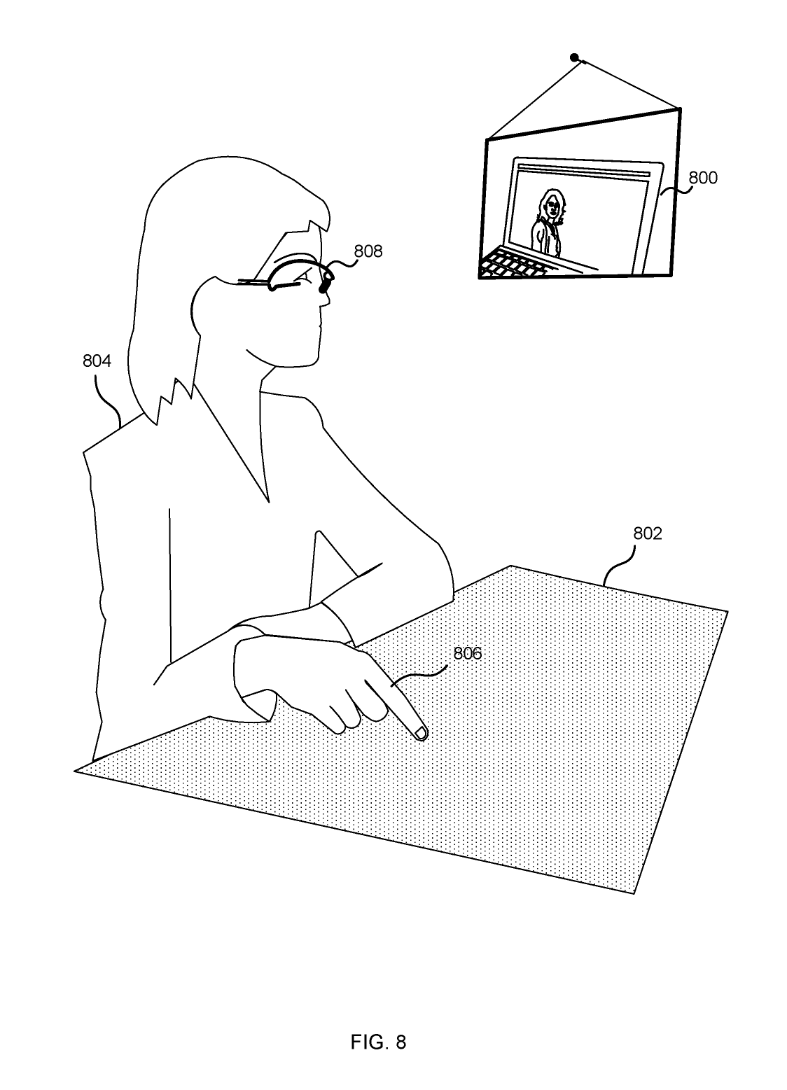

In the case of pointing user input, cameras capture images of a user and a computing system computes from the image data either an absolute pointing direction of the user's finger or a relative pointing position. Using the captured images, tracked pointing direction and/or relative pointing position are computed and used to input electronic ink strokes. A stroke ends when pointing is not detected. Pointing user input for electronic ink is described in more detail below with reference to FIGS. 7 and 8.

In the case of stylus input a user holds a conventional pencil or pen, or a passive stylus (which is powered parasitically by a touch sensor panel), or an active stylus which has its own power supply. The stylus touches or hovers over a display and is used to input electronic ink strokes to an associated computing device. A touch sensor panel detects the conventional pencil and computes positions on the touch sensor panel where the sensor is activated by the pencil. The touch sensor panel is a hover sensitive panel in some cases. The positions are stored as an electronic ink stroke where there are a plurality of positions in a substantially continuous sequence and the stroke ends when input at the sensor panel is no longer detected. In the case of a stylus, the positions are the position of a tip of the stylus computed by the stylus itself or by a combination of the stylus and the touch sensor panel. The stylus is either passive or active.

In various examples described herein, input of electronic ink to a computing device in order to annotate videos or images is facilitated by using an ink mode controller. The ink mode controller controls automatic transitions between at least two modes of the computing device. A mode of a computing device is a state of the computing device in which the computing device is configured to operate in a specified manner, such as to react to user input or other events according to specified rules or operations. In various examples described herein a computing device has at least two modes which are an ink authoring mode and an ink control mode. In some examples, there are three modes which are an ink authoring mode, an ink control mode and a viewing mode. More than three modes are used in some cases.

By automatically transitioning between the modes an end user does not need to manually switch the modes and this reduces burden on the user. The user is able to maintain focus and attention on the drawing of the electronic ink rather than having to manually switch modes. The risk of error in inputting electronic ink to the computing device is also reduced because there is less risk of user input being wrongly detected as electronic ink, or as being detected as electronic ink when it is in fact intended as other user input. In some examples electronic ink is detectable over a greater proportion of the area of a display associated with the computing device in at least one of the modes as compared with at least one other of the modes.

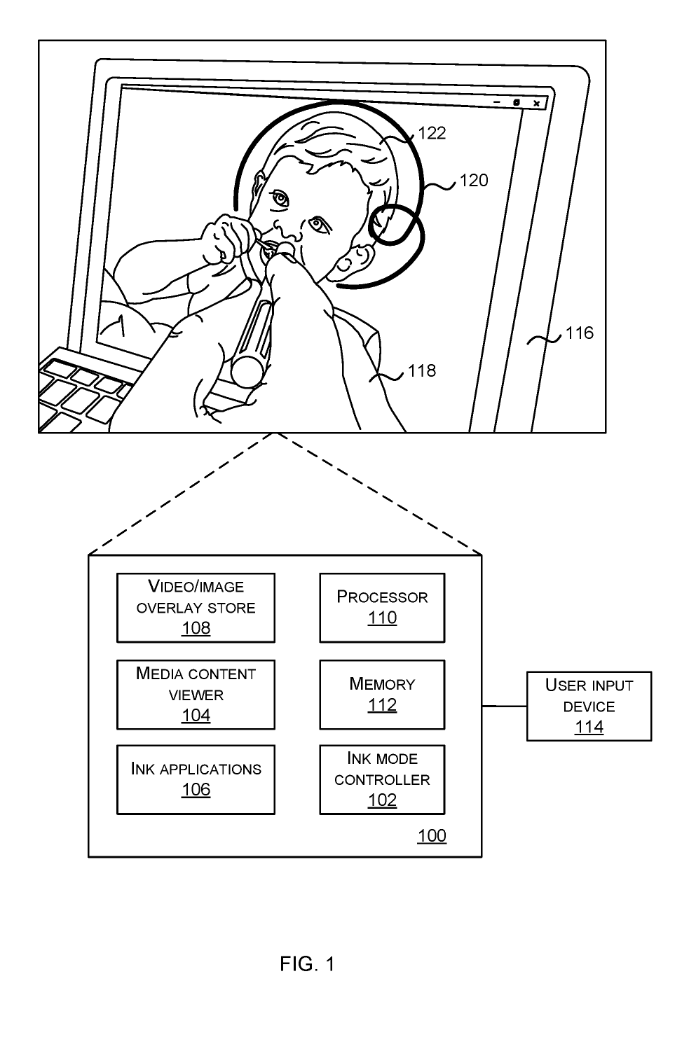

FIG. 1 is a schematic diagram of a computing device 100 which in this case is a laptop computer with a touch screen 116. However, any type of computing device 100 may be used which is associated with a user interface for receiving electronic ink input from a user. A non-exhaustive list of examples of computing device 100 is: smart phone, tablet computer, augmented reality computing device, electronic white board, desk top computer.

The computing device 100 comprises an ink mode controller 102, media content viewer 104, one or more ink applications 106, at least one processor 110, a memory 112 and a store 108 holding one or more overlays for videos or images. The computing device 100 is in communication with at least one user input device 114 such as stylus 118, computer mouse, camera for detecting pointing user input, touch panel sensor or other user input device 114.

The media content viewer 104 is functionality to view media content such as videos or images. In examples using video, the media content viewer 104 comprises a video player which is computer-implemented functionality to receive a video and render the video at a display associated with the computing device 100. The video player may comprise a video decoder which decodes compressed, encoded video prior to rendering of the video at the display. The video player has an associated user interface to enable an end user to control playing of videos. The media content viewer 104 comprises an image viewer in examples where images are annotated with electronic ink. An image viewer is computer implemented functionality to render an image on a display.

The one or more ink applications 106 comprise software to enable authoring of electronic ink.

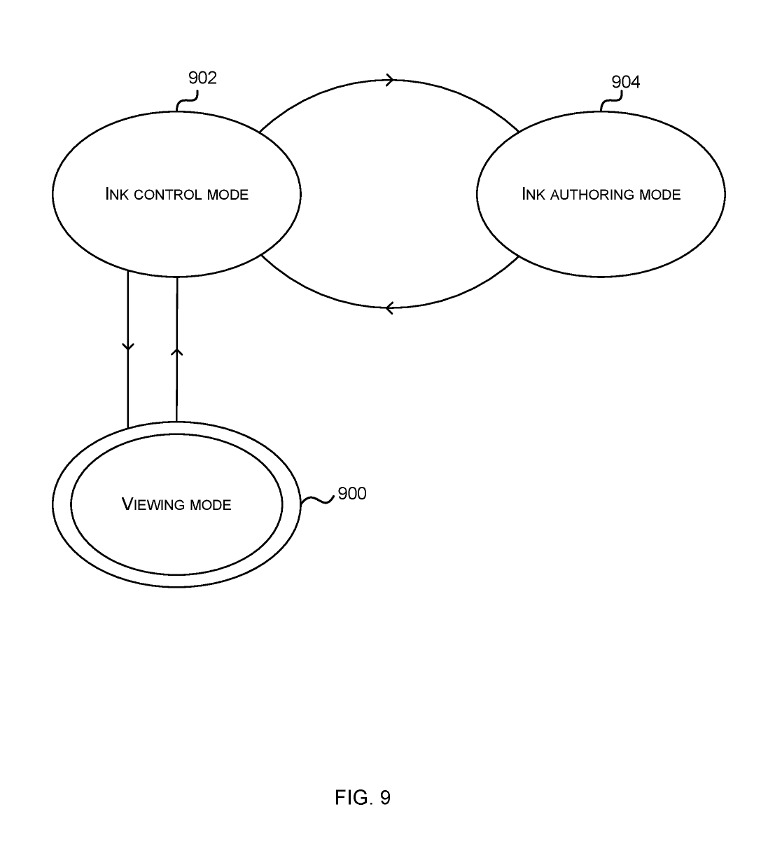

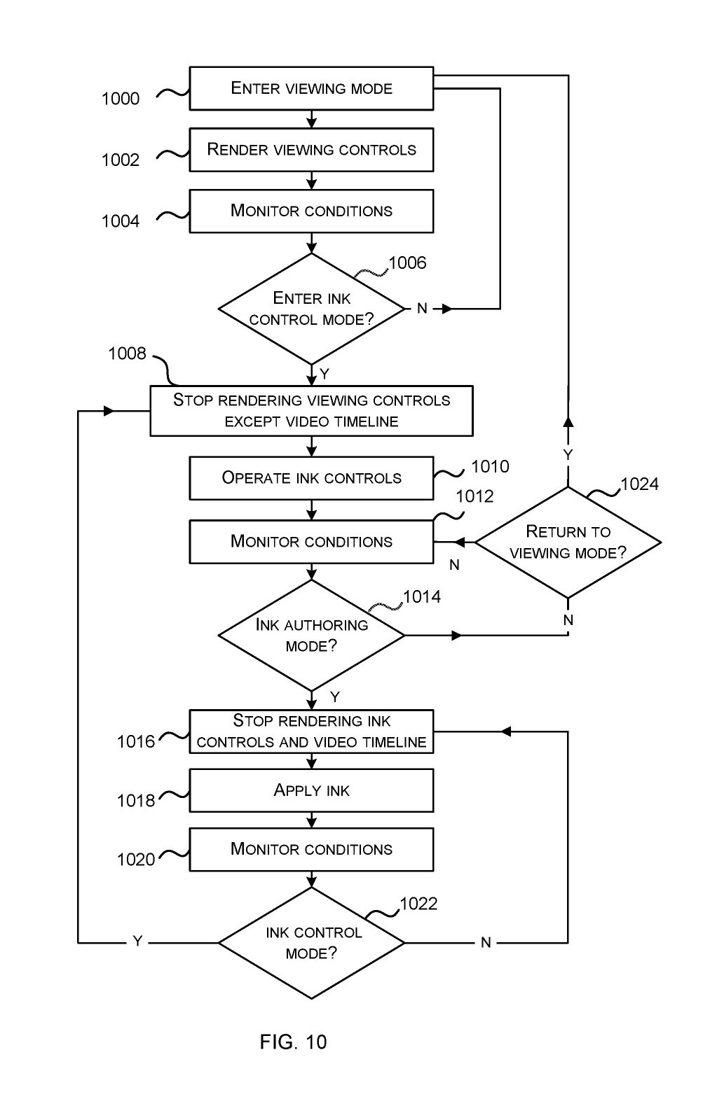

The ink mode controller is 102 is functionality to control which of a plurality of modes the computing device is in at any one time. A method of operation at the ink mode controller 102 is described below with reference to FIGS. 9 and 10.

In the example of FIG. 1 the laptop computer 100 is displaying a video at its touch screen 116 and the video depicts a young child 122. The video is paused at a current frame. A user holding a stylus 118 is drawing electronic ink 120 onto the video frame. The electronic ink itself does not modify the video but rather is stored in an overlay which is rendered over the video. For example, store 108 holds overlays for videos and/or images.

In the example of FIG. 1 the computing device 100 is in an ink authoring mode during which user input is interpreted as electronic ink and stored in an overlay to overlay the frame of the video.

In some examples, some or all of the functionality of the ink mode controller 102, video/image overlay store 108, media content viewer 104 and ink applications 106 is located at a remote computing entity in communication with the computing device 100 via a communications network.

Alternatively, or in addition, the functionality of the ink mode controller 102 and media content viewer 104 described herein is performed, at least in part, by one or more hardware logic components. For example, and without limitation, illustrative types of hardware logic components that are optionally used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), Graphics Processing Units (GPUs).

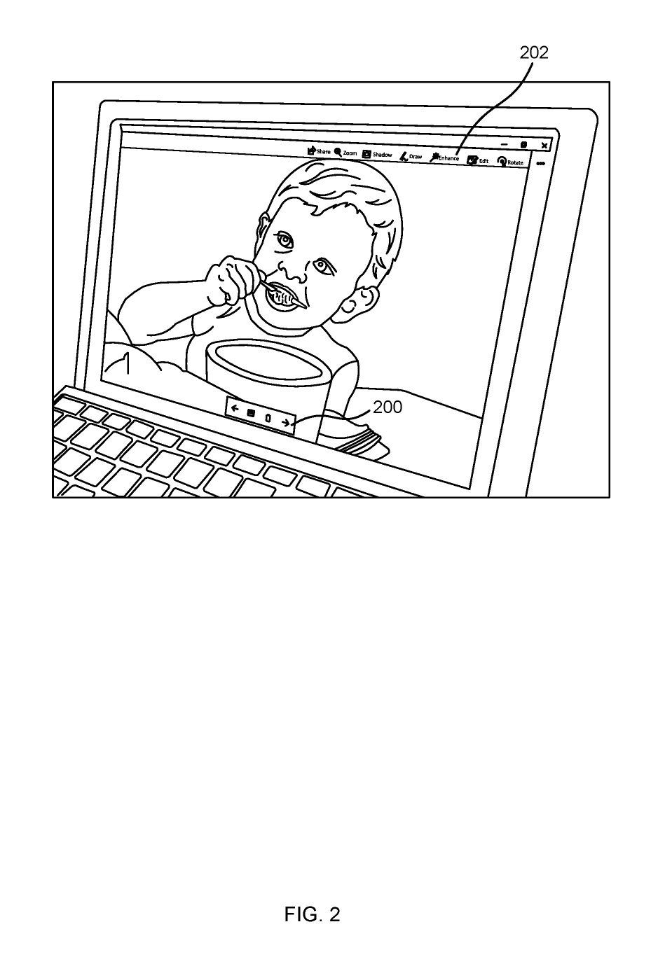

Operation of the computing device 100 is now described with respect to particular examples depicted in FIGS. 2 to 8 which show particular content that is not intended to limit the scope of the technology.

FIG. 2 shows an example where the computing device 100 is in viewing mode. Here an image of a child is displayed on the display screen of the computing device and viewing controls 200 are rendered over part of the displayed image. The viewing controls are selectable elements which trigger actions such as moving to a next image, moving to a previous image, deleting the current image and adding comments to an image. In this example, additional viewing controls 202 are rendered over the top of the image. The additional viewing controls 202 are selectable elements which trigger actions such as sharing the current image, zooming the current image, presenting slideshow of image, drawing on the current image, enhancing the current image, editing the current image, rotating the current image and others. In viewing mode it is not possible to draw ink. In viewing mode it is not possible to operate ink controls such as to change the color of the ink or line weight of the ink.

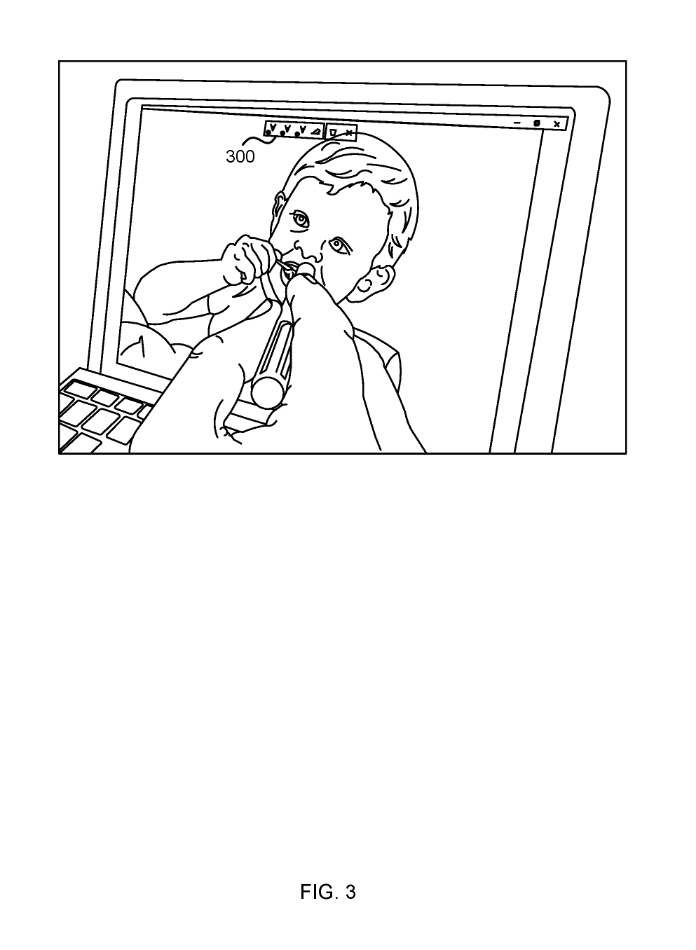

FIG. 3 shows an example where the computing device is in ink control mode. In this example, the image of FIG. 2 is rendered on the display of the computing device 100 and a user operates a stylus to commence drawing electronic ink on the child's face. The ink mode controller has detected conditions which indicate the mode of the computing device is to be transitioned from viewing mode to ink control mode and the transition has taken place so that the computing device is now in ink control mode. In ink control mode ink control elements 300 are rendered over the display of the content (image or video). In the example of FIG. 3 the ink control elements 300 are shown at least partly overlapping the child's head. The ink control elements 300 are graphical elements the user may operate (such as by selecting with a mouse, stylus or finger) to change color of the electronic ink, line weight of the electronic ink and other electronic ink features. Note the ink control elements 300 are obscuring part of the image. In ink control mode it is not possible to draw electronic ink. In ink control mode the content being viewed is static. In ink control mode it is not possible to operate viewing controls such as to play a video or move to a next image of a plurality of images.

FIG. 1 shows the situation where the computing device is in ink authoring mode. Here the image is displayed on the electronic device display screen and the ink control elements are absent. In this example the viewing control elements are also absent. In ink authoring mode it is not possible to use the ink controls to change the color of the ink, line weight of the ink or other features of the ink. In ink authoring mode the content being viewed is static. In ink authoring mode it is not possible to operate viewing controls such as to play a video or move to a next image of a plurality of images.

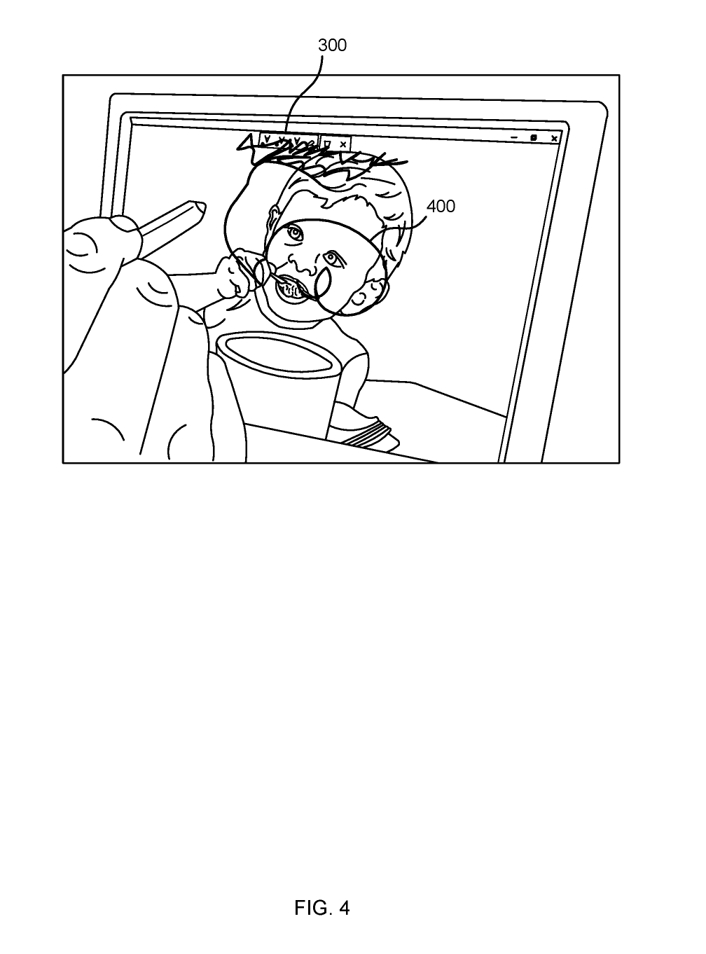

FIG. 4 shows the image of FIG. 1 displayed on the computing device 100 and where the computing device is in ink control mode. The user has drawn electronic ink 400 over the image including in a region of the display screen where the ink control elements were rendered during ink control mode. As the user moves the stylus away from the display screen as indicated in FIG. 4 the ink mode controller 102 detects conditions for transitioning from ink authoring mode to ink control mode. The ink mode controller 102 triggers ink control mode and the computing device renders the ink control elements 300. In this case the ink control elements 300 overlay part of the electronic ink .

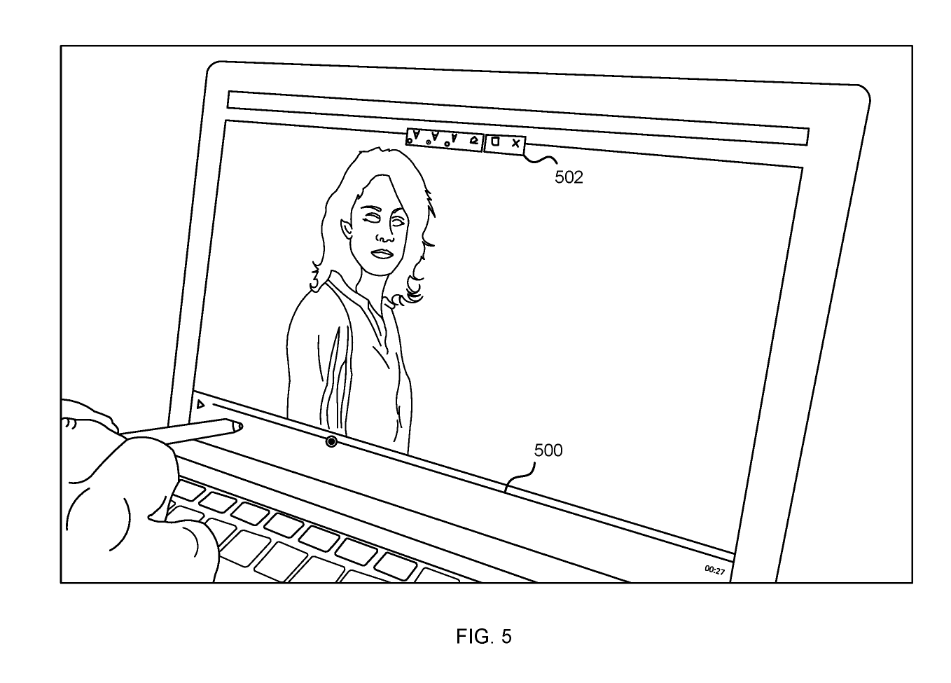

FIG. 5 shows content comprising a video being played at the computing device 100 using media content viewer 104. The video depicts a woman. In this example the computing device is in ink control mode and so ink control elements 502 are rendered over the video as indicated. In this example, a video timeline control element 500 is also rendered over the video as indicated and is operable by a use to move to different frames in the video.

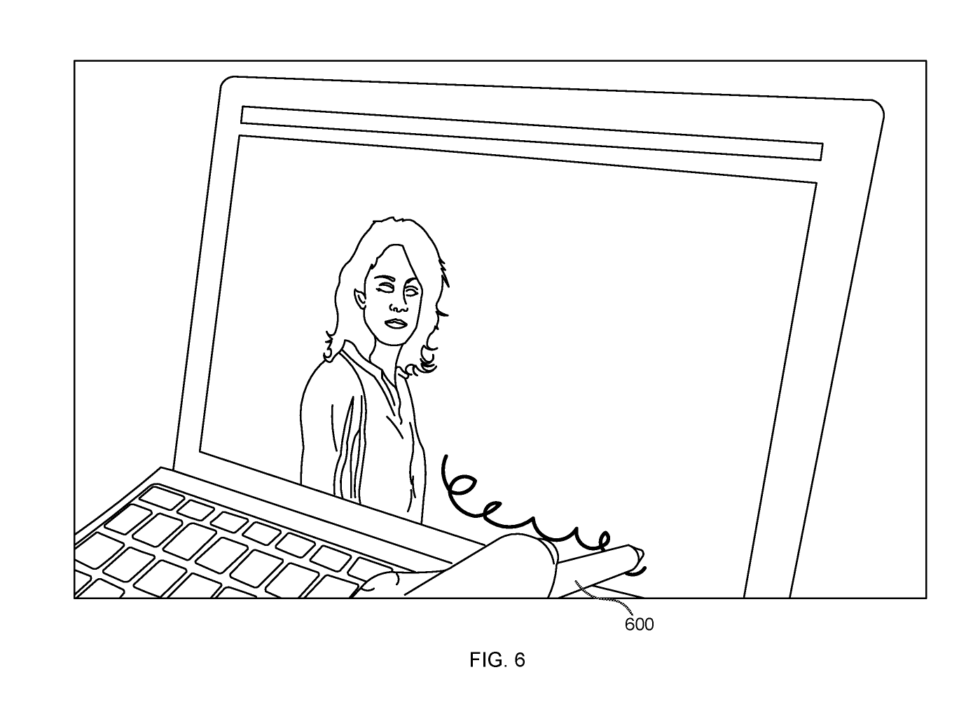

FIG. 6 shows the computing device of FIG. 5 in ink authoring mode. Here the ink control elements 502 and video timeline control element 500 are absent and the user is drawing electronic ink using stylus 600 over the video. The electronic ink is being drawn at a location previously obscured by the video timeline control element 500.

FIG. 7 shows a woman 700 sitting on a sofa 702 and using her hand 706 to point at a display screen 704. Cameras in the room (not shown) capture images of the woman's hand and a computing device 100 in the room, or at a remote location, computes a pointing direction of the woman's finger. The position of the display screen 704 is known from the captured images or from configured data. The computing device 100 computes an absolute or a relative position on the display screen 704 from the pointing direction of the woman's finger. When the computing device 100 is in an electronic ink authoring mode, the position data is used to generate electronic ink.

In the example of FIG. 8 a woman 804 is sitting at a table 802 and using her finger 806 to point at locations on the table top. The user is wearing an augmented reality computing device 808 which has one or more image capture devices and which has one or more projectors to project content into the user's eyes. Images captured by the augmented reality computing device 808 and/or cameras in the room depict the table top and the woman's finger 806. The augmented reality computing device, or another computing device in communication with the augmented reality computing device, computes an absolute or relative position of the woman's finger on the table top and a mapping between that position and a virtual reality display 800 which is projected into the user's eye such that it appears superimposed on a real notice board on a wall of the room where the woman is sitting. Movement of the user's finger on the table top controls movement of a virtual position indicator on the virtual reality display 800 and/or is used to generate electronic ink.

FIG. 9 is a state transition diagram illustrating three modes of an electronic device such as the electronic device 100 of FIG. 1. In this example, three modes are illustrated comprising a viewing mode 900, an ink control mode 902 and an ink authoring mode 904. It is possible to omit the viewing mode 900 in some cases. It is possible to have more than three modes in some cases. Transitions between the modes are indicated by arrows in FIG. 9.

When the media content viewer 104 is started up the electronic device 100 enters a viewing mode 900. The double lines around the viewing mode state in FIG. 9 indicate this is a starting state of the state transition diagram. In this mode, user input events are interpreted as being inputs to the media content viewer 104 such as to start or stop playing of a video, to rotate an image, to browse to a next image, to adjust a volume of an audio track of a video or for other viewing-related actions.

A processor of the computing device 100 is configured to operate in a viewing mode 900 in which the content is played by the media content viewer 104 according to user input received at viewing controls rendered over the content by the processor. The ink mode controller 102 is configured to monitor for and detect specified conditions, and when the specified conditions are detected, to trigger transitioning of the processor between the viewing mode 900 and the ink control mode 902.

The ink mode controller 102 is configured to trigger transitioning of the processor from the viewing mode 900 to the ink control mode 902 if the specified conditions comprise detection of an event comprising at least one of: a stylus touch on the display, a finger touch on a touch screen associated with the display, a mouse click, a pointing user input computed from images of a user operating the computing device, a voice command, selection of an ink control mode icon.

The detected event has an associated location on the display which is anywhere on the display outside the viewing controls.

The ink mode controller 102 is configured to trigger transitioning of the processor from the ink control mode 902 to the viewing mode 900 if the specified conditions comprise detection of an event comprising at least one of: a voice command, selection of a viewing mode icon.

The ink mode controller 102 is configured to trigger transitioning of a process of the computing device 100 between ink control mode 902 and ink authoring mode 904 when it detects conditions which indicate commencement of electronic inking or cessation of electronic inking.

The ink mode controller 102 is configured to trigger transitioning of the processor from the ink control mode 902 to the ink authoring mode 904 on detection of an event comprising at least one of: a stylus touch on the display, a finger touch on a touch screen associated with the display, a mouse click, a pointing user input computed from images of a user operating the computing device, a voice command, selection of an ink authoring mode icon.

The ink mode controller 102 is configured to retain the ink control mode 902 in the case that the detected event occurs in the ink control element, such as where a user touches an ink control element.

In some cases the detected event comprises a location on the display which is outside the ink control element and so the detected event is able to trigger transitioning from the ink control mode 902 to the ink authoring mode 904.

In some cases the ink mode controller 102 is configured to trigger transitioning of the processor from the ink authoring mode 904 to the ink control mode 902 on detection of a time interval during which there is an absence of electronic ink input.

In some cases, in the ink control mode, a processor of the computing device 100 is configured to render at least one ink control element over the content such that part of the content is obscured.

In some cases, the processor is configured, in the ink control mode 902, to render a video timeline control over the content, where the content comprises a video.

In some cases the processor is configured, in the ink authoring mode 904, to render electronic ink over the locations on the display which are occupied by the ink control element(s) during the ink control mode 902.

FIG. 10 is a flow diagram of an example process at a computing device 100 such as a smart phone, personal computer, tablet computer, smart watch, augmented reality computing device, or other computing device 100. Media content viewer functionality is launched on the computing device 100 and used to render content, such as a video or image on a display associated with the computing device 100. A processor of the computing device enters a viewing mode 1000 as a result. In the viewing mode, the processor renders 1002 viewing controls on a display associated with the computing device 100 so that the viewing controls are over at least part of the content in some examples. An ink mode controller 102 monitors conditions such as times, user input events, processor events, operating system events or other events and checks 1006 whether to transition to an ink control mode. If the ink mode controller 102 decides not to trigger transition to the ink control mode the computing device remains in viewing mode and the process returns to operation 1000. If the ink mode controller 102 decides to trigger transition to the ink control mode the ink control mode is entered. In the ink control mode a processor of the computing device stops 1008 rendering the viewing controls, except for a video timeline in some cases where the content comprises a video. The processor operates 1010 ink controls by rendering one or more ink control elements over at least part of the content and checking for user selection of the ink control element(s). If an ink control element is selected the processor modifies the rendering of the electronic ink accordingly.

The ink mode controller 102 monitors 1012 conditions such as times, user input events, processor events, operating system events or other events and checks 1014 whether to enter ink authoring mode or not. If the ink mode controller 102 decides not to enter ink authoring mode it checks 1024 whether to return to viewing mode. If so, the process returns to operation 1000. If not, the process moves to operation 1012.

If the ink mode controller decides at check 1014 to move to ink authoring mode, the processor is configured to stop 1016 rendering the ink controls, and where applicable, the video timeline. In ink authoring mode the processor detects user input and applies 1018 electronic ink as a result. The electronic ink is stored in an overlay to be superimposed or rendered over the content. The ink mode controller monitors conditions at operation 1020 and according to checks 1022 on those conditions it decides whether to return to ink control mode or to remain in ink authoring mode. If there is a return to ink control mode the process moves to operation 1008. If there is a decision to remain in ink authoring mode the process moves to operation 1016.

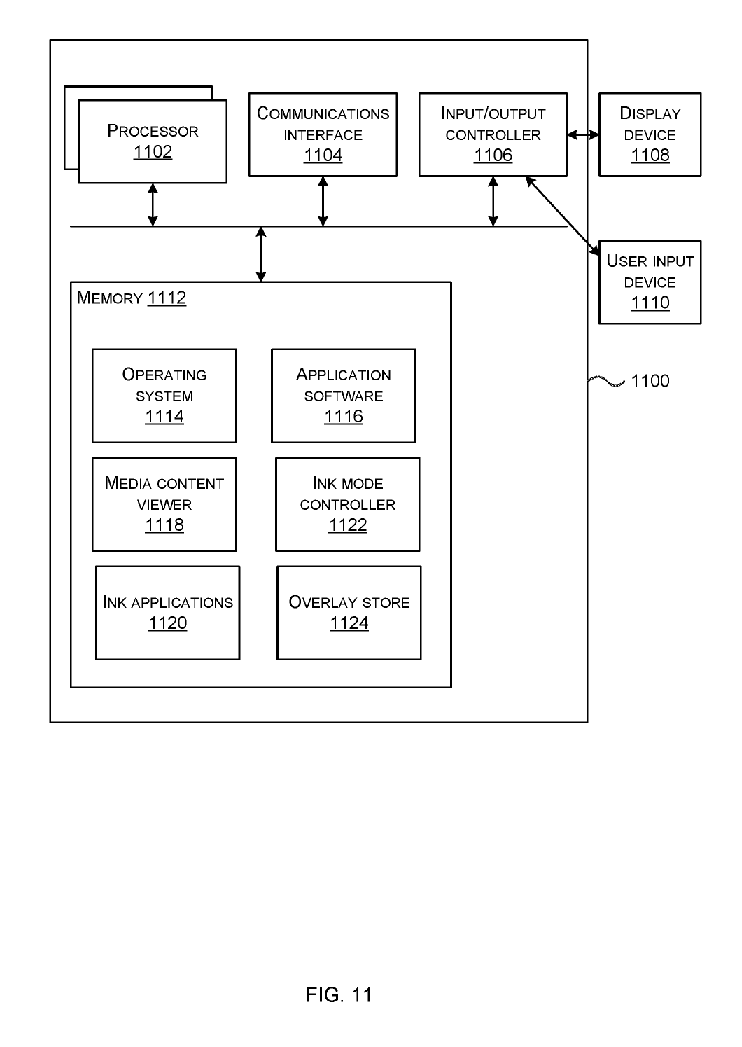

FIG. 11 illustrates various components of an exemplary computing-based device 1100 which are implemented as any form of a computing and/or electronic device, and in which embodiments of an ink mode controller 1122 are implemented in some examples.

Computing-based device 1100 comprises one or more processors 1102 which are microprocessors, controllers or any other suitable type of processors for processing computer executable instructions to control the operation of the device in order to control which mode the computing-based device is in and to control transitions between modes, in order to facilitate input of electronic ink to the computing-based device 1100. In some examples, for example where a system on a chip architecture is used, the processors 1102 include one or more fixed function blocks (also referred to as accelerators) which implement a part of the method of FIGS. 9 and 10 in hardware (rather than software or firmware). Platform software comprising an operating system 1114 or any other suitable platform software is provided at the computing-based device to enable application software 1116 to be executed on the device. The application software 1116 may be electronic ink annotation on video applications, electronic ink animation applications, electronic ink editing applications and others. A media content viewer 1118 is provided at the computing-based device 1100.

The computer executable instructions are provided using any computer-readable media that is accessible by computing based device 1100. Computer-readable media includes, for example, computer storage media such as memory 1112 and communications media. Computer storage media, such as memory 1112, includes volatile and non-volatile, removable and non-removable media implemented in any method or technology for storage of information such as computer readable instructions, data structures, program modules or the like. Computer storage media includes, but is not limited to, random access memory (RAM), read only memory (ROM), erasable programmable read only memory (EPROM), electronic erasable programmable read only memory (EEPROM), flash memory or other memory technology, compact disc read only memory (CD-ROM), digital versatile disks (DVD) or other optical storage, magnetic cassettes, magnetic tape, magnetic disk storage or other magnetic storage devices, or any other non-transmission medium that is used to store information for access by a computing device. In contrast, communication media embody computer readable instructions, data structures, program modules, or the like in a modulated data signal, such as a carrier wave, or other transport mechanism. As defined herein, computer storage media does not include communication media. Therefore, a computer storage medium should not be interpreted to be a propagating signal per se. Although the computer storage media (memory 1112) is shown within the computing-based device 1100 it will be appreciated that the storage is, in some examples, distributed or located remotely and accessed via a network or other communication link (e.g. using communication interface 1104). Memory 1112 includes an overlay store 1124 for video/image overlays where the overlays comprise electronic ink to be superimposed on a video or image.

The computing-based device 1100 also comprises an input/output controller 1106 arranged to output display information to a display device 1108 which may be separate from or integral to the computing-based device 1100. The display information may provide a graphical user interface. The input/output controller 1106 is also arranged to receive and process input from one or more devices, such as a user input device 1110 (e.g. a touch panel sensor, stylus, mouse, keyboard, camera, microphone or other sensor). In some examples the user input device 1110 detects voice input, user gestures or other user actions and provides a natural user interface (NUT). This user input may be used to author electronic ink, view content, select ink controls, play videos with electronic ink overlays and for other purposes. In an embodiment the display device 1108 also acts as the user input device 1110 if it is a touch sensitive display device. The input/output controller 1106 outputs data to devices other than the display device in some examples, e.g. a locally connected printing device.

Any of the input/output controller 1106, display device 1108 and the user input device 1110 may comprise natural user interface (NUI) technology which enables a user to interact with the computing-based device in a natural manner, free from artificial constraints imposed by input devices such as mice, keyboards, remote controls and the like. Examples of NUI technology that are provided in some examples include but are not limited to those relying on voice and/or speech recognition, touch and/or stylus recognition (touch sensitive displays), gesture recognition both on screen and adjacent to the screen, air gestures, head and eye tracking, voice and speech, vision, touch, gestures, and machine intelligence. Other examples of NUI technology that are used in some examples include intention and goal understanding systems, motion gesture detection systems using depth cameras (such as stereoscopic camera systems, infrared camera systems, red green blue (rgb) camera systems and combinations of these), motion gesture detection using accelerometers/gyroscopes, facial recognition, three dimensional (3D) displays, head, eye and gaze tracking, immersive augmented reality and virtual reality systems and technologies for sensing brain activity using electric field sensing electrodes (electro encephalogram (EEG) and related methods).

Alternatively or in addition to the other examples described herein, examples include any combination of the following:

A computing device comprising:
a media content viewer configured to render content comprising an image or a video at a display associated with the computing device;
a processor configured to operate in at least an ink control mode and an ink authoring mode, whereby in the ink control mode at least one ink control element is rendered over a display of the content, the ink control element being selectable by a user to change settings for electronic inking over the content, and whereby in the ink authoring mode user input generates electronic ink over the content; and
an ink mode controller configured to monitor for and detect specified conditions, and when the specified conditions are detected, to trigger transitioning of the processor between the ink control mode and the ink authoring mode.

The computing device described above wherein the specified conditions comprise conditions which indicate commencement of electronic inking or cessation of electronic inking.

The computing device described above wherein the ink mode controller is configured to trigger transitioning of the processor from the ink control mode to the ink authoring mode on detection of an event comprising at least one of: a stylus touch on the display, a finger touch on a touch screen associated with the display, a mouse click, a pointing user input computed from images of a user operating the computing device, a voice command.

The computing device described above wherein the ink mode controller is configured to retain the ink control mode in the case that the detected event occurs in the ink control element.

The computing device described above wherein the detected event comprises a location on the display which is outside the ink control element.

The computing device described above wherein the ink mode controller is configured to trigger transitioning of the processor from the ink authoring mode to the ink control mode on detection of a time interval during which there is an absence of electronic ink input.

The computing device described above wherein the processor is configured, in the ink control mode, to render the at least one ink control element over the content such that part of the content is obscured.

The computing device described above wherein the processor is configured, in the ink control mode, to render a video timeline control over the content, where the content comprises a video.

The computing device described above wherein the processor is configured, in the ink authoring mode, to render electronic ink over the locations on the display which are occupied by the ink control element(s) during the ink control mode.

The computing device described above wherein the processor is configured to operate in a viewing mode in which the content is played by the media content viewer according to user input received at viewing controls rendered over the content by the processor.

The computing device described above wherein the ink mode controller is configured to monitor for and detect specified conditions, and when the specified conditions are detected, to trigger transitioning of the processor between the viewing mode and the ink control mode.

The computing device described above wherein the ink mode controller is configured to trigger transitioning of the processor from the viewing mode to the ink control mode if the specified conditions comprise detection of an event comprising at least one of: a stylus touch on the display, a finger touch on a touch screen associated with the display, a mouse click, a pointing user input computed from images of a user operating the computing device, a voice command.

The computing device described above wherein the detected event has an associated location on the display which is anywhere on the display outside the viewing controls.

The computing device described above wherein the ink mode controller is configured to trigger transitioning of the processor from the ink control mode to the viewing mode if the specified conditions comprise detection of an event comprising at least one of: a voice command, a user input event associated with a specified location on the display.

A computer-implemented method comprising:
rendering content comprising an image or a video at a display associated with the computing device;
operating a processor in one of: an ink control mode and an ink authoring mode, whereby in the ink control mode at least one ink control element is rendered over a display of the content, the ink control element being selectable by a user to change settings for electronic inking over the content, and whereby in the ink authoring mode user input generates electronic ink over the content; and
monitoring for and detecting specified conditions, and when the specified conditions are detected, triggering transitioning of the processor between the ink control mode and the ink authoring mode.

The method described above comprising triggering transitioning of the processor from the ink control mode to the ink authoring mode on detection of an event comprising at least one of: a stylus touch on the display, a finger touch on a touch screen associated with the display, a mouse click, a pointing user input computed from images of a user operating the computing device, a voice command.

The method described above comprising retaining the ink control mode in the case that the detected event occurs in the ink control element.

The method described above comprising, in the ink control mode, rendering the at least one ink control element over the content such that part of the content is obscured.

The method described above comprising, in the ink authoring mode, rendering electronic ink over the locations on the display which are occupied by the ink control element(s) during the ink control mode.

A computing device comprising:
a media content viewer configured to render content comprising an image or a video at a display associated with the computing device;
a processor configured to operate in at least an ink control mode and an ink authoring mode, whereby in the ink control mode at least one ink control element is rendered over a display of the content, the ink control element being selectable by a user to change settings for electronic inking over the content, and whereby in the ink authoring mode the ink control element(s) are hidden and user input generates electronic ink over the content; and
an ink mode controller configured to monitor for and detect specified conditions, and when the specified conditions are detected, to trigger transitioning of the processor between the ink control mode and the ink authoring mode.

A computing device comprising:
means for rendering content comprising an image or a video at a display associated with the computing device;
means for operating a processor in one of: an ink control mode and an ink authoring mode, whereby in the ink control mode at least one ink control element is rendered over a display of the content, the ink control element being selectable by a user to change settings for electronic inking over the content, and whereby in the ink authoring mode user input generates electronic ink over the content; and
means for monitoring for and detecting specified conditions, and when the specified conditions are detected, triggering transitioning of the processor between the ink control mode and the ink authoring mode.

For example, the means for rendering content is the media content viewer 104, the means for operating a processor is the ink mode controller 102 and the means for monitoring and detecting specified conditions is the ink mode controller.

The term ‘computer’ or ‘computing-based device’ is used herein to refer to any device with processing capability such that it executes instructions. Those skilled in the art will realize that such processing capabilities are incorporated into many different devices and therefore the terms ‘computer’ and ‘computing-based device’ each include personal computers (PCs), servers, mobile telephones (including smart phones), tablet computers, set-top boxes, media players, games consoles, personal digital assistants, wearable computers, and many other devices.

The methods described herein are performed, in some examples, by software in machine readable form on a tangible storage medium e.g. in the form of a computer program comprising computer program code means adapted to perform all the operations of one or more of the methods described herein when the program is run on a computer and where the computer program may be embodied on a computer readable medium. The software is suitable for execution on a parallel processor or a serial processor such that the method operations may be carried out in any suitable order, or simultaneously.

This acknowledges that software is a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions are optionally distributed across a network. For example, a remote computer is able to store an example of the process described as software. A local or terminal computer is able to access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a digital signal processor (DSP), programmable logic array, or the like.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The operations of the methods described herein may be carried out in any suitable order, or simultaneously where appropriate. Additionally, individual blocks may be deleted from any of the methods without departing from the scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

The term ‘subset’ is used herein to refer to a proper subset such that a subset of a set does not comprise all the elements of the set (i.e. at least one of the elements of the set is missing from the subset).

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the scope of this specification.

What is claimed is:

1. A computing device comprising:
a media content viewer configured to render content comprising an image or a video at a display associated with the computing device;
a processor configured to operate in at least an ink control mode and an ink authoring mode, whereby in the ink control mode at least one ink control element is rendered over a display of the content, the ink control element being selectable by a user to change settings for electronic inking over the content, and whereby in the ink authoring mode user input generates electronic ink over the content; and
an ink mode controller configured to monitor for and detect specified conditions, and when the specified conditions are detected, to trigger transitioning of the processor between the ink control mode and the ink authoring mode.

2. The computing device of claim 1 wherein the specified conditions comprise conditions which indicate commencement of electronic inking or cessation of electronic inking.

3. The computing device of claim 1 wherein the ink mode controller is configured to trigger transitioning of the processor from the ink control mode to the ink authoring mode on detection of an event comprising at least one of: a stylus touch on the display, a finger touch on a touch screen associated with the display, a mouse click, a pointing user input computed from images of a user operating the computing device, a voice command.

4. The computing device of claim 3 wherein the ink mode controller is configured to retain the ink control mode in the case that the detected event occurs in the ink control element.

5. The computing device of claim 3 wherein the detected event comprises a location on the display which is outside the ink control element.

6. The computing device of claim 1 wherein the ink mode controller is configured to trigger transitioning of the processor from the ink authoring mode to the ink control mode on detection of a time interval during which there is an absence of electronic ink input.

7. The computing device of claim 1 wherein the processor is configured, in the ink control mode, to render the at least one ink control element over the content such that part of the content is obscured.

8. The computing device of claim 1 wherein the processor is configured, in the ink control mode, to render a video timeline control over the content, where the content comprises a video.

9. The computing device of claim 1 wherein the processor is configured, in the ink authoring mode, to render electronic ink over the locations on the display which are occupied by the ink control element(s) during the ink control mode.

10. The computing device of claim 1 wherein the processor is configured to operate in a viewing mode in which the content is played by the media content viewer according to user input received at viewing controls rendered over the content by the processor.

11. The computing device of claim 10 wherein the ink mode controller is configured to monitor for and detect specified conditions, and when the specified conditions are detected, to trigger transitioning of the processor between the viewing mode and the ink control mode.

12. The computing device of claim 11 wherein the ink mode controller is configured to trigger transitioning of the processor from the viewing mode to the ink control mode if the specified conditions comprise detection of an event comprising at least one of: a stylus touch on the display, a finger touch on a touch screen associated with the display, a mouse click, a pointing user input computed from images of a user operating the computing device, a voice command.

13. The computing device of claim 12 wherein the detected event has an associated location on the display which is anywhere on the display outside the viewing controls.

14. The computing device of claim 11 wherein the ink mode controller is configured to trigger transitioning of the processor from the ink control mode to the viewing mode if the specified conditions comprise detection of an event comprising at least one of: a voice command, a user input event associated with a specified location on the display.

15. A computer-implemented method comprising:
rendering content comprising an image or a video at a display associated with the computing device;
operating a processor in one of: an ink control mode and an ink authoring mode, whereby in the ink control mode at least one ink control element is rendered over a display of the content, the ink control element being selectable by a user to change settings for electronic inking over the content, and whereby in the ink authoring mode user input generates electronic ink over the content; and
monitoring for and detecting specified conditions, and when the specified conditions are detected, triggering transitioning of the processor between the ink control mode and the ink authoring mode.

16. The method of claim 15 comprising triggering transitioning of the processor from the ink control mode to the ink authoring mode on detection of an event comprising at least one of: a stylus touch on the display, a finger touch on a touch screen associated with the display, a mouse click, a pointing user input computed from images of a user operating the computing device, a voice command.

17. The method of claim 16 comprising retaining the ink control mode in the case that the detected event occurs in the ink control element.

18. The method of claim 15 comprising, in the ink control mode, rendering the at least one ink control element over the content such that part of the content is obscured.

19. The method of claim 15 comprising, in the ink authoring mode, rendering electronic ink over the locations on the display which are occupied by the ink control element(s) during the ink control mode.

20. A computing device comprising:
a media content viewer configured to render content comprising an image or a video at a display associated with the computing device;
a processor configured to operate in at least an ink control mode and an ink authoring mode, whereby in the ink control mode at least one ink control element is rendered over a display of the content, the ink control element being selectable by a user to change settings for electronic inking over the content, and whereby in the ink authoring mode the ink control element(s) are hidden and user input generates electronic ink over the content; and
an ink mode controller configured to monitor for and detect specified conditions, and when the specified conditions are detected, to trigger transitioning of the processor between the ink control mode and the ink authoring mode.
